(19) United States
(12) Patent Application Publication
(10) Pub. No.: US 2019/0078873 A1
(43) Pub. Date: Mar. 14, 2019

(54) METHODS AND SYSTEMS FOR THICKNESS MEASUREMENT OF MULTI-LAYER STRUCTURES

(71) Applicant: TETECHS INC., Waterloo (CA)

(72) Inventors: Daryoosh SAEEDKIA, Waterloo (CA); Daniel HAILU, Waterloo (CA)

(21) Appl. No.: 16/084,099

(22) PCT Filed: Apr. 4, 2017
(86) PCT No.: PCT/CA2017/050409

§ 371 Date: Sep. 11, 2018

Related U.S. Application Data
(60) Provisional application No. 62/317,890, filed on Apr. 4, 2016.

(51) Int. Cl. G01B 11/06; G01S 13/10; G01S 17/10

(52) U.S. Cl. CPC G01B 11/06; G01S 17/10; G01S 13/10

(57) ABSTRACT

A system and method for measuring thicknesses of layers of a multi-layered structure, The method includes generating a terahertz wave pulse, transmitting the terahertz wave pulse to a multi-layered structure having multiple layers of materials, receiving reflected terahertz wave pulses reflected by boundaries between the multiple layers as the terahertz wave pulse penetrates the structure, and processing the reflected terahertz wave pulses to: (i) measure the time delays associated with each of the reflected terahertz pulses and (ii) determine a thickness of each of the multiple layers of materials based upon the time delay and a material refractive index of each of the materials.

This application claims the benefit of U.S. Provisional Patent Application Ser. No. 62/317,890 filed on Apr. 4, 2016, by the present inventor, and entitled “METHODS AND APPARATUS FOR THICKNESS MEASUREMENT OF MULTI-LAYER STRUCTURES”, the entire contents of which are hereby incorporated by reference herein for all purposes.

### TECHNICAL FIELD

The embodiments disclosed herein relate to methods for measuring thickness of individual layers in multi-layer structures using terahertz waves.

### INTRODUCTION

Non-contact, non-invasive multi-layer thickness measurement of plastic, rubber, ceramic, composite materials, foam, web, paper, and sheet is one of the major challenges found in many industries, such as plastic manufacturing, hose and tubes, paper, plastic bottles and preforms manufacturing.

Conventional technology to measure the wall thickness of transparent plastic bottles, and preforms, uses infrared interferometry which cannot measure opaque materials. Another conventional method uses Hall Effect (e.g., Magna-mike) measurement probes. Measurements are made when the magnetic probe is held or scanned on one side of the test material and a small target ball (or disk or wire) is placed on the opposite side of the test material or dropped inside a container. The probe's Hall Effect sensor measures the distance between the probe tip and target ball. This method is time consuming, only measures overall wall thickness and cannot measure multi-layer structures, and may not be integrated into manufacturing lines.

As an example, multi-layer thickness measurement for opaque and transparent plastic preforms in the plastic industry may be used for quality control and inspection of manufactured plastic bottles and preforms. A problem in the plastic industry is the measurement of the barrier layer in multi-layer plastic bottle and preforms. The barrier layer may prevent egress and ingress of gas such as carbon dioxide and oxygen, block light, and keep contents fresh. Currently multi-layer perform thickness measurement is done by cutting the sample, pealing the layers and weighting them, which is a time consuming and destructive process. To date, there is no effective technology that satisfactorily addresses the opaque and transparent multilayer thickness measurement of plastic preforms and bottles in plastic industry. The plastic industry has a need to use non-contact, non-destructive, and non-invasive method to determine existence of the barrier and thickness of each layer in multi-layer plastic bottle or preform.

### SUMMARY

According to some embodiments, there is a method for measuring thicknesses of layers of a multi-layered structure. The method includes generating a terahertz wave pulse, transmitting the terahertz wave pulse to the multi-layered structure having multiple layers of materials, receiving reflected terahertz wave pulses reflected by boundaries between the multiple layers as the terahertz wave pulse penetrates the multi-layered structure, and processing the reflected terahertz wave pulses to: (i) measure time delays associated with each of the reflected terahertz pulses and (ii) determine a thickness of each of the multiple layers of materials based upon the time delays and a material refractive index of each of the materials.

The method may further include determining a maximum peak of a first pulse reflection and a minimum peak of a last pulse reflection in the reflected terahertz wave and adding a region around the first pulse reflection with positive peak to the last pulse reflection with the negative peak after aligning the peaks of the first and last pulses in the reflected terahertz wave to determine an extracted barrier reflection pulse.

The extracted barrier reflection pulse may have a peak time delay at the time of reflection from the boundaries between the multiple layers.

The method may further include storing a time index of the maximum peak of the first pulse reflection, the minimum peak of the last pulse reflection, and the extracted barrier reflection pulse.

The method may further include extracting weak reflections from the reflected terahertz beam.

The method may further include recording a terahertz signal monolayer waveform, recording a reference monolayer waveform, and subtracting the monolayer waveform from the terahertz signal monolayer waveform.

The method may further include determining the overall thickness of the multi-layer structure.

The multi-layer structure may be a transparent and opaque preform and wherein the multi-layer structure includes a first layer, a second layer, and a barrier layer between the first layer and the second layer.

When the reflected terahertz wave pulses with sub-picosecond pulse width overlap, signal processing may be performed to extract barrier reflections.

According to some embodiments, there is a system for measuring thicknesses of layers of a multi-layered structure. The system includes a driver for producing a terahertz wave pulse, a terahertz photoconductive transmitter for transmitting the terahertz wave pulse to the structure having multiple layers of materials, a terahertz photoconductive receiver for receiving reflected terahertz wave pulses reflected by boundaries between the multiple layers as the terahertz wave pulse penetrates the multi-layered structure, and a processor for processing the reflected terahertz wave pulses to: (i) measure time delays associated with each of the reflected terahertz pulses and (ii) determine a thickness of each of the multiple layers of materials based upon the time delays and a material refractive index of each of the materials.

The system may further include a terahertz beam splitter for splitting the terahertz pulsed wave to form first and second wave beams.

The system may further include a shaker for providing an optical delay in the second wave beam.

The system may further include a translational stage and a retro-reflector mirror for changing the optical path delay in the second wave beam.

The system may further include a low-noise amplifier for amplifying and converting the current from the terahertz photoconductive antenna to an amplified voltage signal that is recorded to form a terahertz waveform.

The system may further include an exit parabolic mirror for separating the transmitted and received terahertz wave pulses.

The system may further include a laser diode for indicating the position of terahertz focus of the multi-layered structure.

The system may further include a pair of off axis mirrors for separating the transmitted and received terahertz wave pulses.

The system may further include a plurality of dielectric mirrors for redirecting the terahertz wave pulse.

The terahertz photoconductive transmitter and receiver are fixed to a gauge chassis.

According to one aspect, there is provided a method for thickness measurement of multi-layer structures such as opaque and transparent plastic bottles, preforms, paper, web and sheet, rubber and plastic hoses and tubes using terahertz waves. A terahertz wave pulse is generated by terahertz sources and interacts with the materials and multilayer structure under test and the transmitted and/or reflected terahertz waves through/off the materials are detected by terahertz detectors. The echoes of the incident Terahertz (THz) pulse are reflected from the walls and layers of the multilayer structure such as a preform or bottle under test.

Terahertz pulses penetrate materials such as, for example, plastics, rubber, ceramic and paper, and are reflected at each material/air or multi-layer boundary. The THz pulses from the transmitter go to the multi-layer structure or sample under test and the reflected pulses from the sample are coupled into the THz detector. The reflected THz pulses from the multi-layer sample have their time delay measured that corresponds to the thickness of the layers of the sample under test such as plastic preform and plastic bottle. The peak amplitudes of the reflected pulses also decrease as they experience absorption loss and Fresnel reflections.

The reflected terahertz pulses have their time delays related to the material refractive index in the terahertz range. The Terahertz pulse reflected from the walls, and layers of the plastic preform bottles have a specific time delay that allows a user to calculate the thickness of each wall and of an opaque and/or transparent material structure such as plastic preform and bottle. For preforms, bottles, hoses and tubes, the terahertz measurement method includes signal processing to extract the reflections from the inner layers of the multilayer material structure and determine the peak and minimum position in time delay of each echo pulse.

In some cases, the reflected and/or transmitted terahertz pulses are analyzed and signal processed to extract the weak reflections from the noise and features of the terahertz signal waveform that distorts the pulse shape of the raw waveform before signal processing. The terahertz measurement method involves signal processing for multilayer structure by recording the terahertz signal waveform for the case of a monolayer structure such as preform, where the sample is a multi-layer wall brought to the focus of the terahertz beam, and the recorded reference monolayer terahertz waveform is removed from the sample multi-layer terahertz waveform measurement in order to remove the effects of the common deterministic feature which is result of the measurement condition. When the reference terahertz waveform is subtracted from the multi-layer sample terahertz waveform, the weak reflections from the inner layers becomes more predominant.

The problem addressed here is the measurement of the wall thickness and multi-layer thickness measurement of opaque and transparent plastic preforms, bottles, paper, plastic and rubber hoses, foam, web and sheet using a non-contact, non-invasive, and non-destructive measurement method.

As an example, multi-layer thickness measurement for opaque and transparent plastic preforms in the plastic industry for quality control and inspection of manufactured plastic bottles and preforms. The terahertz measurement system can pass through opaque and transparent plastics and preforms and measures the multi-layer thickness of each layer.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a schematic diagram of an exemplary thickness measurement system, in accordance with an embodiment;

FIG. 1B is a terahertz waveform, in accordance with an exemplary embodiment;

FIG. 2 is a schematic diagram of an exemplary terahertz sensor system operating in reflection mode, in accordance with an embodiment;

FIG. 3 is a schematic diagram of an exemplary terahertz sensor system operating in reflection mode, in accordance with a further embodiment;

FIG. 4 is a Terahertz Pulse Measurement Trace after signal processing to extract the barrier layer for a PET Multi-layer Preform Sample or PET/Nylon/PET Preform;

FIG. 5A is a flow chart of a method for measuring thicknesses of layers of a multi-layered structure, in accordance with an embodiment;

FIG. 5B is a schematic diagram of a method for determining overall thickness and barrier thickness in multilayer transparent and opaque preforms using a terahertz sensor system operating in reflection mode;

FIG. 6 is a Terahertz Pulse Measurement Trace before signal processing to extract the barrier layer for a PET Multi-layer Preform Sample or PET/Nylon/PET Preform;

FIG. 7 is a schematic diagram of a method for determining overall thickness and barrier thickness in multilayer transparent and opaque bottles using a terahertz sensor system operating in reflection mode;

FIG. 8 is a Terahertz Pulse Measurement Trace after signal processing to extract the barrier layer for a HDPE Multi-layer Bottle with Ethylene vinyl alcohol (EVOH) layer. The first pulse reflection from the outer layer is used to extract the reflection from EVOH layer as the thickness is thin and the reflected pulse from the barrier and outer layer of the wall overlap and so the reflection from the EVOH layer should be extracted from the superposition of the two pulses in the terahertz waveform;

FIG. 9 is a schematic diagram of a method for determining thickness of individual layers and barrier thickness in multilayer transparent and opaque bottles using terahertz sensor system operating in reflection mode; and

FIG. 10 is a Terahertz Pulse Measurement Trace and Simulated fit for a Multilayer Medical plastic bottle with reflection from Barrier layer, and inner layer of the wall.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Many materials including polymers, plastics, organic and inorganic materials, rubber, ceramics, papers and cupboards, glasses, etc. are transparent or semi-transparent to terahertz waves. There is a need to measure multi-layer thickness of structures such as preforms, bottle and web and sheet that are made with these materials. A reflection or transmission-mode terahertz time-domain system, that uses a pair of terahertz transmitter and receiver, is used to measure reflected echoes from the layers of a multi-layer structure. Many of these multi-layer materials are opaque to visible light, and near-infrared light making conventional thickness measurement for advanced manufacturing impossible. This makes terahertz waves an ideal tool to do single and multi-layer thickness measurement based on their properties at terahertz frequencies.

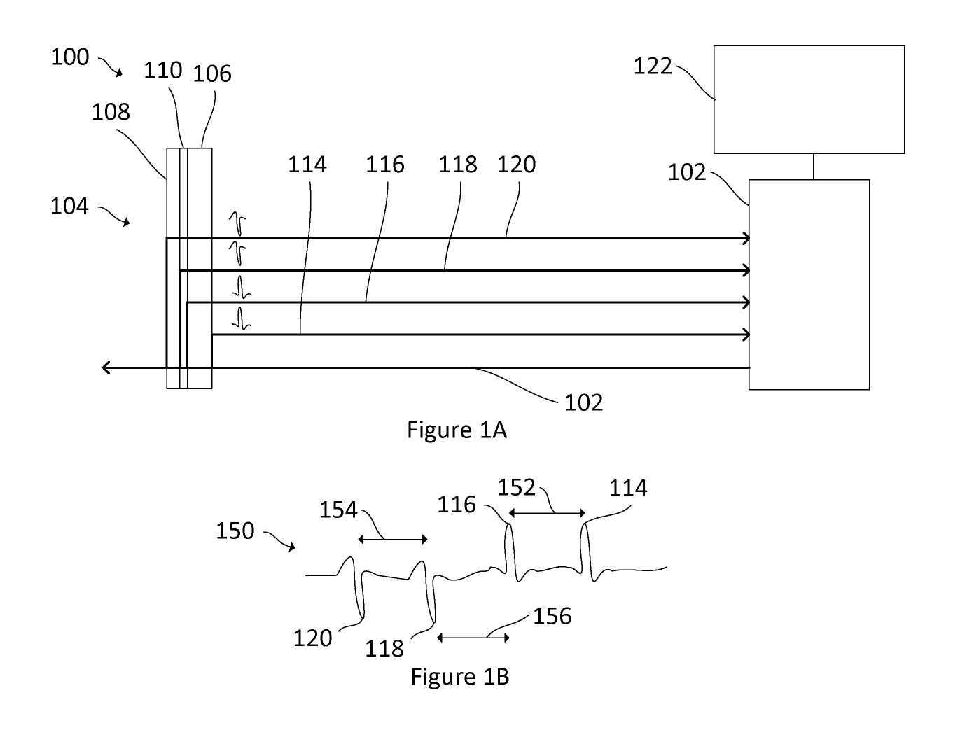

Referring now to FIG. 1A, illustrated therein is a sample measurement system 100, in accordance with an embodiment. The sample measurement system 100 includes a terahertz sensor system 102 for conducting thickness measurement on a sample under test 104. Terahertz are electromagnetic waves within the ITU-designated band of frequencies from 0.3 to 3 terahertz (THz; 1 THz=1012 Hz). Wavelengths of radiation in the terahertz band correspondingly range from 1 mm to 0.1 mm (or 100 μm).

The sample 104 is multi-layered material having a first layer 106 and a second layer 108. The sample 104 includes a barrier layer 110 between the first layer 106 and the second layer 108. The sample 104 may be a preform, hose, tubes, or bottles. The sample 104 may be made of materials such as plastics, rubber, ceramic, papers etc. For example, the first and second layers 106 may be PET (polyethylene terephthalate) or HDPE (high-density polyethylene) and the barrier layer 110 may be EVOH (ethylene vinyl alcohol) or nylon.

The terahertz sensor system 102 produces a terahertz incident pulse 112. The terahertz wave is a wide band terahertz pulse 112 generated by a terahertz wide band source such as a terahertz photoconductive antenna.

The incident pulse 112 is reflected at the material-air and multi-layer boundaries to create reflected pulses 114, 116, 118, 120. The reflected pulses 114, 116, 118, 120 are received into the terahertz sensor system 102.

FIG. 1B illustrates a measured trace 150, of the reflected pulses 114, 116, 118, 120. The reflected trace 150 includes time delays 152, 154, 156 of the reflected THz pulses 114, 116, 118, 120. The time delays 152, 154, 156 are compared to a thickness reference index to determine the thickness of the first layer 106, the second layer 108, and the boundary layer 110 of the sample 104. The reflected trace 150 includes peak amplitudes which may also decrease as the reflected pulses 114, 116, 118, 120 experience absorption loss and Fresnel reflections.

The system 100 includes a processing device 122 for processing the signals, 114, 116, 116, 120. The device 122 may include one or more of a memory, a secondary storage device, a processor, an input device, a display device, and an output device. Memory may include random access memory (RAM) or similar types of memory. Also, memory may store one or more applications for execution by processor. Applications may correspond with software modules comprising computer executable instructions to perform processing for the functions described below. Secondary storage device may include a hard disk drive, floppy disk drive, CD drive, DVD drive, Blu-ray drive, or other types of non-volatile data storage. Processor may execute applications, computer readable instructions or programs. The applications, computer readable instructions or programs may be stored in memory or in secondary storage, or may be received from the Internet or other network. Input device may include any device for entering information into device 122. For example, input device may be a keyboard, key pad, cursor-control device, touch-screen, camera, or microphone. Display device may include any type of device for presenting visual information. For example, display device may be a computer monitor, a flat-screen display, a projector or a display panel. Output device may include any type of device for presenting a hard copy of information, such as a printer for example. Output device may also include other types of output devices such as speakers, for example. In some cases, device 122 may include multiple of any one or more of processors, applications, software modules, second storage devices, network connections, input devices, output devices, and display devices.

Although device 122 is described with various components, one skilled in the art will appreciate that the device 122 may in some cases contain fewer, additional or different components. In addition, although aspects of an implementation of the device 122 may be described as being stored in memory, one skilled in the art will appreciate that these aspects can also be stored on or read from other types of computer program products or computer-readable media, such as secondary storage devices, including hard disks, floppy disks, CDs, or DVDs; a carrier wave from the Internet or other network; or other forms of RAM or ROM. The computer-readable media may include instructions for controlling the device 122 and/or processor to perform thickness measurement.

In particular, the processer 122 is configured to process the reflected terahertz wave pulses. The processor 122 is configured to measure the time delays associated with each of the reflected terahertz pulses. The processor 122 is configured to determine a thickness of each of the multiple layers of materials based upon the time delay and a material refractive index of each of the materials.

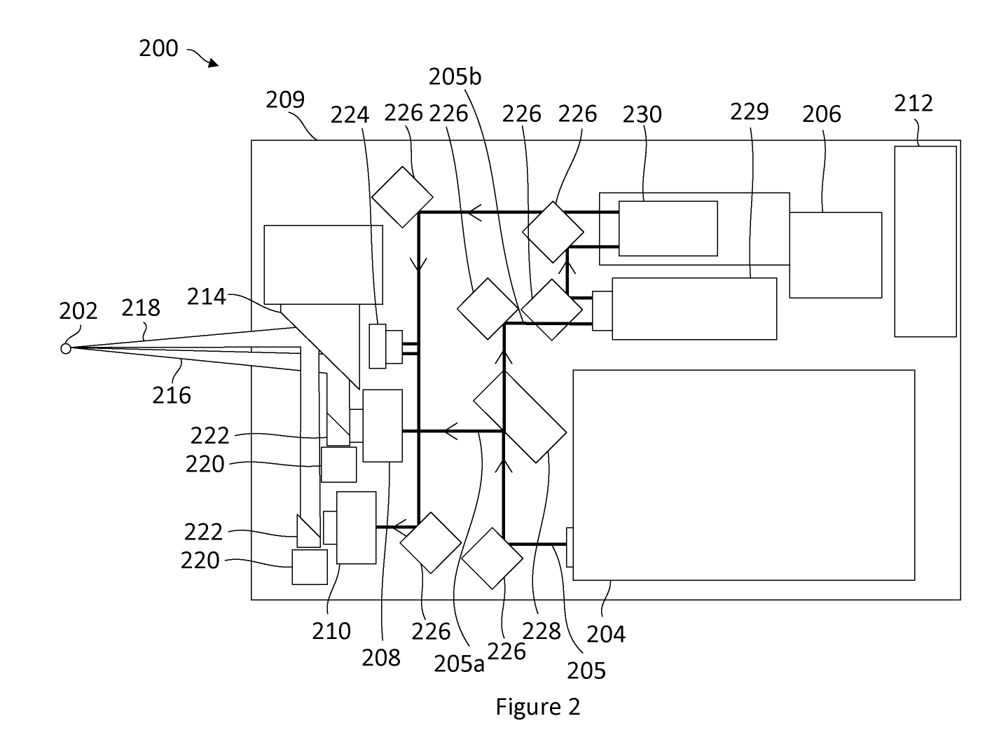

Referring now to FIG. 2, illustrated therein is a terahertz sensor system 200 for measuring thickness of a multi-layered structure sample 202, in accordance with an embodiment. The terahertz system 200 includes a driver 204 for producing a pulsed wave light beam 205. The driver 204 drives the time-domain system and produces a pulsed laser beam with a pulse width generally in the femtosecond range.

The system 200 includes an optical beam splitter 228 for splitting the terahertz pulsed laser beam 205. The optical beam splitter 228 may be a 1″ optical beam splitter. The pulsed wave laser beam 205 is split by the beam splitter 228 to form split pulsed wave laser beams 205a and 205b.

The system 200 includes a terahertz transmitter 208 for receiving the pulsed light beam 205a and for generating and transmitting terahertz radiation 216. The system 200 includes a terahertz detector 210 for receiving the pulsed light beam 205b and the sample-influenced terahertz radiation 218 reflected from the multi-layered structure 202 and generating a time varying current correlatable therewith.

Terahertz transmitter 208 may include a first photoconductive antenna having electrodes, and a voltage source for providing a voltage bias to the electrodes, wherein the first photoconductive antenna receives beam 205a output from driver 204 to modulate its conductance in order to generating terahertz radiation 216. The first terahertz photoconductive antenna of the terahertz transmitter 208 transmits the terahertz pulsed beam 216.

When the beam 205a impinges onto the first photoconductive antenna, the conductivity of the photoconductive antenna will increase, thus generating a current that results in terahertz radiation 216. The frequency of the radiation 216 depends on the mode and configuration of the beam 205a provided by the driver 204.

Terahertz detector 210 may include a second photoconductive antenna configured to receive beam 205b output from the driver 204, which modulates its conductance in order to generate time varying current. A sample-influenced time varying voltage is induced in the second photoconductive antenna upon receiving terahertz radiation 218. The received terahertz radiation 218 will be sample-influenced and possesses additional information relating to the sample 202. The sample-influenced time varying current is collected from the electrodes and correlated to the sample-influenced induced time varying voltage and the modulated conductance of the second photoconductive antenna.

The free-air terahertz photoconductive antennas transmit and receive terahertz waves reflected from the samples under test 202. The terahertz transmitter 208 and the terahertz receiver 201 may be fixed to a gauge chassis 209 to provide increased stability.

The terahertz radiation 216 is used to non-invasively probe the sample 202, which results in generating the sample-influenced terahertz radiation 218, which is received by the second photoconductive antenna. The beam 205b is used to excite the photoconductive antenna and modulate its conductance. Upon receiving the sample-influenced terahertz radiation 218, a time varying voltage v(t) is induced across the electrodes and a corresponding time varying current i(t) is measured. A time varying electric field E(t) may be computed from the measured i(t) and a Fourier transform may be done to derive the frequency response F(s) of E(t). The system output for further processing may be in the form of the above mentioned frequency response F(s), time varying electric field E(t), or the time varying current i(t).

The pulsed beam 205a is used to excite the first photoconductive antenna for generating pulsed terahertz radiation 216. The pulsed beam 205b is used to excite the second photoconductive antenna for detecting terahertz radiation. The operator may select the modes of terahertz generation and detection based on sampling requirements such as resolution and frequency range.

The wave pulse 205 that contains a range of frequencies (according to the Fourier synthesis of a pulse waveform) is used to modulate the conductance of the photoconductive antenna at a range of frequencies. In turn, the generated terahertz radiation 216 will contain a wide spectrum of terahertz frequencies. The actual range of the frequencies may be controlled by varying the pulse width of the pulsed wave laser 205.

The system 200 includes a linear stage or shaker 206 for providing an optical delay line for the pulsed beam 205b. The linear stage or a shaker 206 is used as an optical delay line for the pump-probe beam terahertz measurement setup. The high speed optical delay may be mounted on the long distance optical delay. The beam 205b is fed to a translational stage 229 controlled by a computer (e.g., 122 of FIG. 1). A retro-reflector mirror 230 is used to change the optical path delay in the probe beam path for coherent detection of incident THz wave by the photoconductive antenna. The retro-reflector 230 may be a 0.75″ retro-reflector.

Changing the optical path delay in the probe beam path can be done by increasing the probe beam optical path by moving the retro-reflector mirror 230 further away from the direction of the incoming probe beam. By using the motorized translational stage 229 to introduce delay in the probe beam path, an operator can bring the probe beam to the receiver photoconductive antenna with different time delays with respect to the incident THz wave, which makes it possible to record the samples of the incident THz wave at the lock-in at sub-picosecond time intervals and reconstruct the THz electric field.

The system includes a low-noise amplifier 212 for amplifying and converting the current from the terahertz photoconductive antenna to an amplified voltage signal that is recorded to form the terahertz waveform. The low-noise amplifier 212 amplifies and converts the current from the terahertz antenna 208 to an amplified voltage signal that is recorded to form a terahertz waveform.

The system includes an exit parabolic mirror 214 for separating the transmitted 216 and received 218 terahertz pulsed beam. This allows for 100% of the signal to be directed on target, instead of losing 50% for every pass through a silicon beam splitter. The parabolic mirror 214 may be large to allow more angular variation in sample position.

The system 200 includes an adjustment stages 220 for adjusting the location of the terahertz photoconductive antenna 208 and a focusing lens 222 for focusing the terahertz pulsed beam. The adjustment stages 200 may be XY adjustment stages. The focusing lens 222 may be a 0.5″ focusing lens.

The system may further include a laser diode 224 for indicating the position of terahertz focus of the multi-layered structure 202.

The system 200 includes a plurality of dielectric mirrors 226 for redirecting the laser pulsed beam. The dielectric mirrors 226 may be 0.5″ dielectric mirrors.

The system 200 may be connected to a computer (e.g., the processor 122) to process terahertz signals and perform certain aspects of the methods described herein.

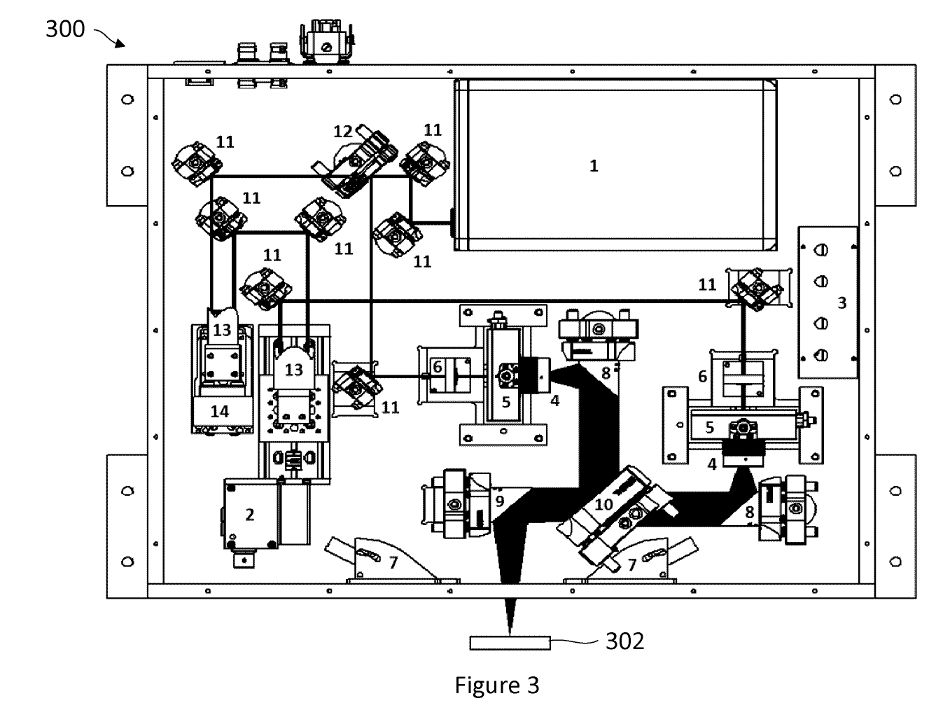

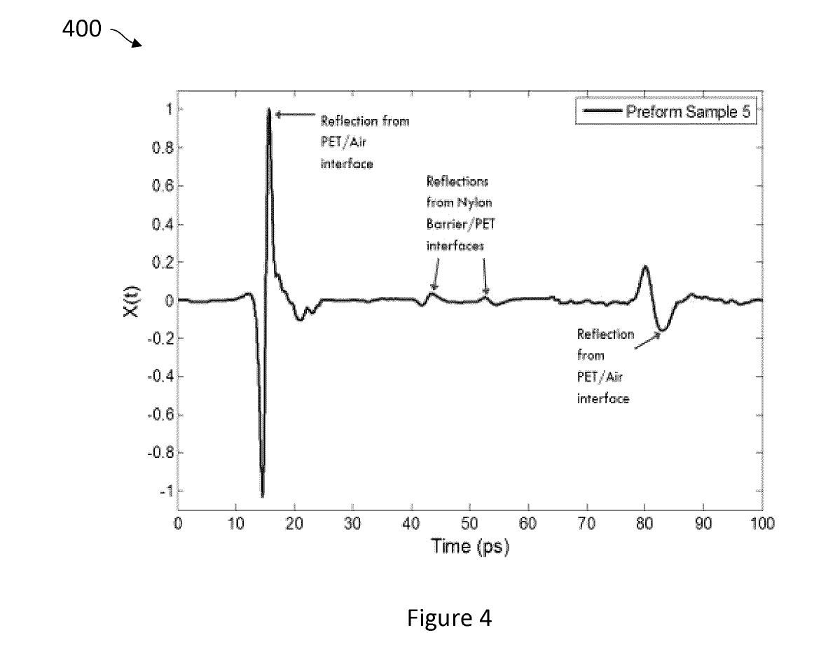

Referring now to FIG. 3, illustrated therein is schematic diagram of a terahertz sensor system 300 made in accordance with exemplary embodiment. The terahertz sensor system includes a first component 1 that drives the time-domain system and a femtosecond pulsed Laser. The terahertz system also includes a linear stage or a shaker 2, a low-noise amplifier 3 (LNA), and terahertz antennas and receivers 4. The linear stage or a shaker 2 is used as an optical delay line for the pump-probe beam terahertz measurement setup. The low-noise amplifier 3 amplifies and converts the current from the terahertz antenna 4 to an amplified voltage signal that is recorded to form the terahertz waveform in FIG. 4. The free-air terahertz photoconductive antenna transmitters and receivers 4 transmit and receive terahertz waves reflected from the samples under test 302.

The terahertz sensor system also includes other optical components used in the system including XY adjustment stages 5, focusing lens 6 (e.g., of 0.5″), laser diodes as indicator of position of terahertz focus of the object 7, FL off axis mirrors 8 (e.g., of 4″), FL off axis mirror 9 (e.g., of 6″), THz beam splitter 10 (e.g., of 2″), dielectric Mirrors 11 (e.g., of 0.5″), optical beam splitter 12 (e.g., of 1″), and retro-reflector 13 (e.g., of 0.75″).

Referring now to FIG. 4 illustrated therein is a schematic diagram 400 of a the terahertz reflection-mode measurement for a transparent PET preform that shows the reflection from the first interface between air and PET (outside interface), reflection from PET and Barrier interface, and then reflection from the last interface between air and PET (inside surface). From the difference between the time delays of these three reflected pulses, and known refractive index in the terahertz range, the system calculates the thickness of the layers.

The terahertz waveform is shown after signal processing to remove the effect of the reference mono-layer structure such as preform terahertz waveform from the multilayer structure terahertz waveform trace. The echo pulses have positive polarity when going from less dense to more dense medium such as from air to PET and have negative polarity when going from dense to less dense medium. The time delay in picoseconds is measured and the peaks of the echo pulses going from the less dense to dense layer and minimum or negative peak of echo pulses for pulses going from more dense to less dense material layer is also measured.

For the mono-layers, the overall thickness can be found based on the reflection of the Terahertz pulses and using the formula that the thickness in millimeters is related to the time delay Δt between peaks of the pulse in picoseconds, the refractive index of the material PET, n, the speed of light c, which is 0.3 mm/ps and factor of 2 for the distance traveled by the probe beam in the THz-time domain setup is twice because of the retro-reflector delay line, gives the relation: d=(Δt×c)/2n.

For the case of multi-layers the refractive index of the material of the barrier is used in the thickness calculation of the barrier layer. The cases of multi-layer preforms, bottles, and hoses and tubes, the signal processing method involves recording the reference single-layer structure terahertz waveform and removing it from the multi-layer structure terahertz waveform in order to extract the reflections of the inner layers which are weak because the contrast between the inner barrier layer materials is close to the outside layer material.

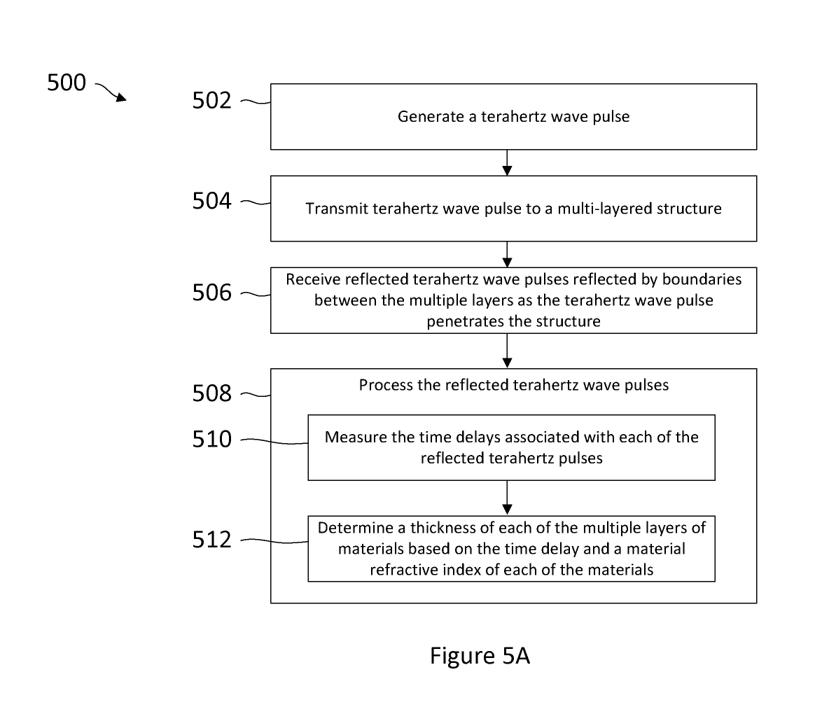

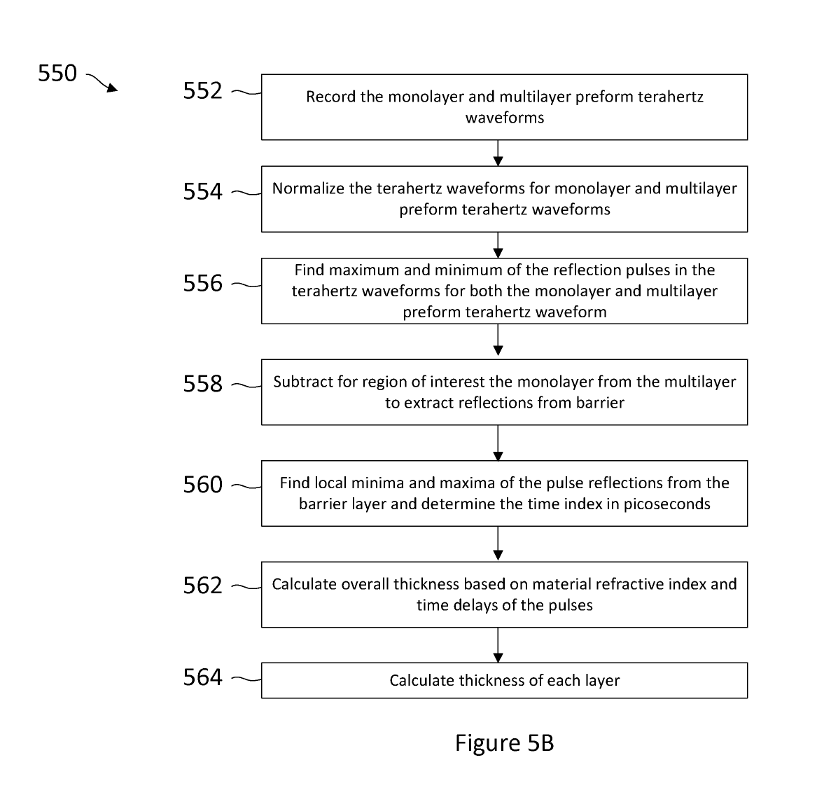

Referring now to FIG. 5A, illustrated therein is a method 500 for measuring thicknesses of layers of a multi-layered structure. At 502, a terahertz wave pulse is generated. At 504, the terahertz wave pulse is transmitted to a multi-layered structure having multiple layers of materials. At 506, reflected terahertz wave pulses are received. The reflected terahertz wave pulses are reflected by boundaries between the multiple layers as the terahertz wave pulse penetrates the structure. At 508, the reflected terahertz wave pulses are received. At 510, the time delays associated with each of the reflected terahertz pulses are measured. At 512, a thickness of each of the multiple layers of materials is determined based upon the time delay and a material refractive index of each of the materials. The thickness of the barrier layer may also be determined. The location of the barrier layer and the location of each of the multiple layers may also be determined.

Referring now to FIG. 5B illustrated therein is schematic diagram of a method 550 for determining overall thickness and barrier thickness and location in multilayer transparent and opaque preforms using the subject terahertz sensor system operating in reflection mode. The monolayer preform is brought to the focus of the terahertz beam that is emitted from the terahertz gauge measurement device and a reference waveform recorded at 552 for signal processing and extraction of the terahertz pulses from the barrier reflections. At 554, the terahertz waveforms are normalized for monolayer and multilayer preform terahertz waveforms.

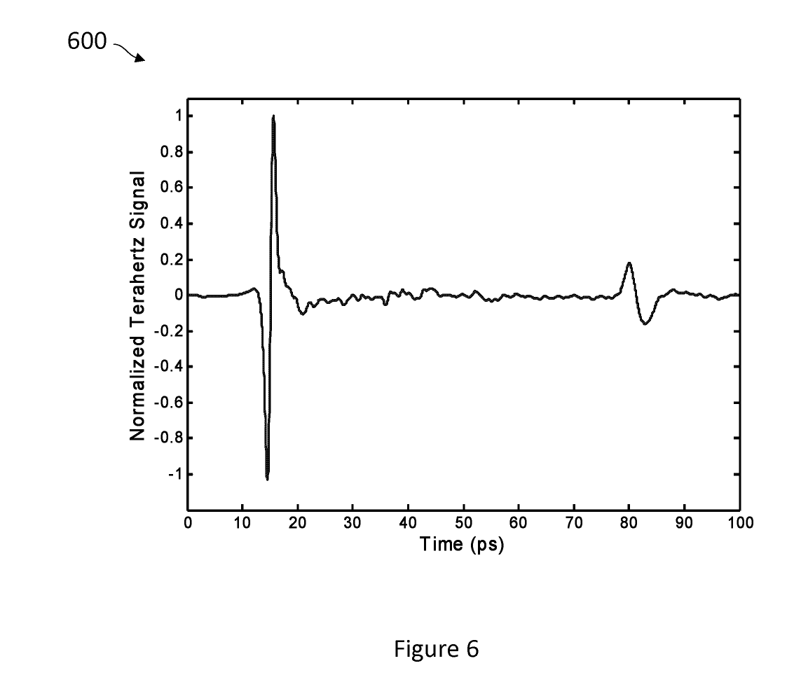

The multilayer preform is placed at the focus of the terahertz beam and the reflections from the outer, barrier and inner layers for the preform recorded in a terahertz waveform similar to shown in FIG. 6. Then the Monolayer terahertz waveform is subtracted at 558 from the Multilayer terahertz waveform in order to make the reflections from the barrier more prominent. The resulting waveform after processing is shown in FIG. 4.

At 556, the first local maxima of the pulse reflection waveform from the barrier for the case of the refractive index of barrier layer such as Nylon being greater than the first layer such as PET, and the second local minima from the reflection going from the barrier to the inner layer gives the time delay at 560 in picoseconds between the pulses. From the echo of the pulses after signal processing and using the refractive index, the overall thickness and thickness of each layer including the barrier is calculated at 562. For the case of the barrier refractive index being lower than the inner and outer layers in the terahertz range, the first local minima and second local maxima from the barrier reflections is used to determine the barrier thickness and location and thickness and location of each layer at 564.

Referring now to FIG. 6 illustrated therein is a Terahertz Pulse Measurement Trace 600 before signal processing to extract the barrier layer for a PET Multi-layer Preform Sample or PET/Nylon/PET Preform. The measured terahertz signal shows that the barrier reflections are not clear and need signal processing and use of proposed method to extract the barrier reflections with result shown in FIG. 4. The present method to extract the barrier reflections and thickness can be used for both transparent and opaque preforms.

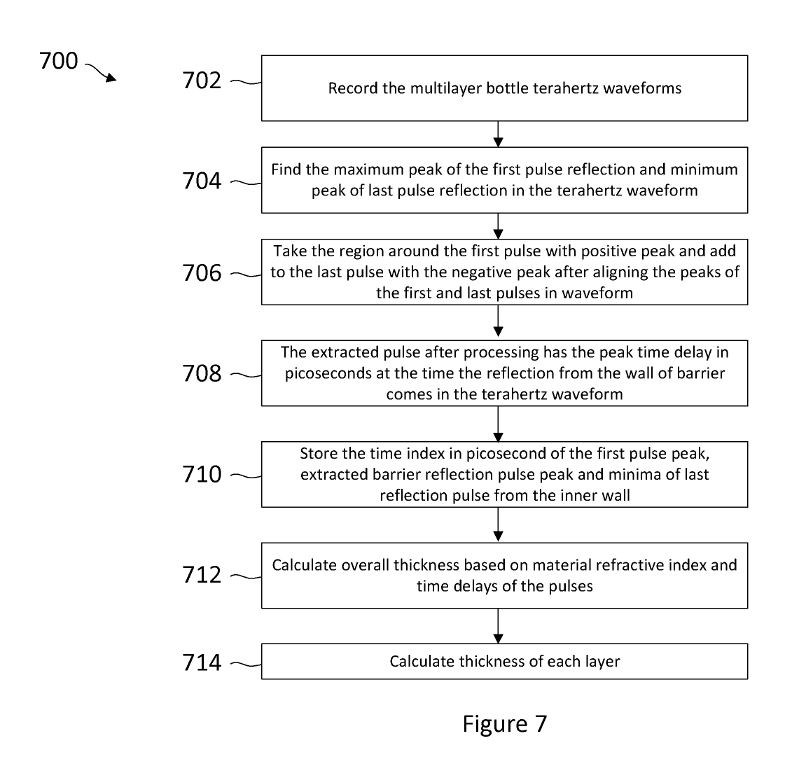

Referring now to FIG. 7 illustrated therein is schematic diagram of a method 700 to determine overall thickness and barrier thickness in multilayer transparent and opaque bottles using terahertz sensor system made in accordance with an exemplary embodiment. For the Multilayer bottles made with materials that are not as dispersive and are lossless in terahertz range such as Polyethylene (HDPE, PP, etc.) the multilayer bottle terahertz waveforms are measured and recorded 702 with the terahertz pulses reflected from the layers in the bottle.

When the barriers are very thin, the reflected pulses with sub-picosecond pulse width overlap and hence need signal processing to extract the reflections from the barriers.

The barrier thickness extraction process for bottles involves finding at 704 maximum peak of the first pulse reflection and minimum peak of last pulse reflection in the terahertz waveform, then the region around the first pulse with positive peak is taken at 706 and add to the last pulse with the negative peak after aligning the peaks of the first and last pulses in waveform. At 708, the extracted pulse after processing has the peak time delay in picoseconds at the time the reflection from the wall of barrier comes in the terahertz waveform. Then the time index in picosecond of the first pulse peak, extracted barrier reflection pulse peak and minima of last reflection pulse from the inner wall is stored at 710 and overall thickness is calculated at 712 based on Material Refractive Index and time delays of the pulses. The thickness of each layer is calculated at 714.

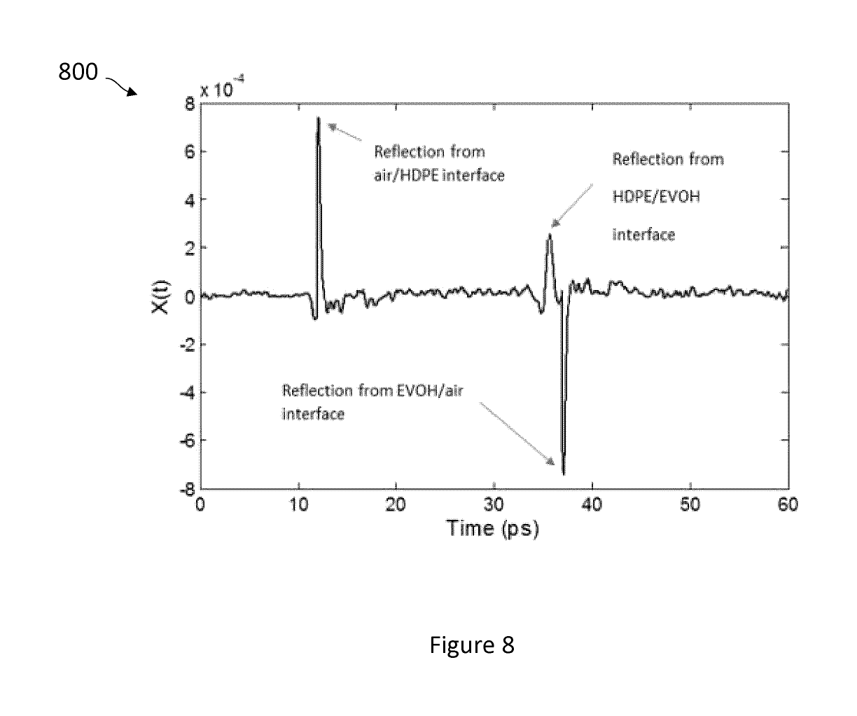

Referring now to FIG. 8 illustrated therein are measurement results 800 collected from a terahertz sensor thickness measurement system after signal processing to extract the barrier layer for a HDPE multi-layer bottle with EVOH layer is accordance with an exemplary embodiment. The terahertz waveform after extracting the barrier reflections and other cases where the barrier reflections can be obtained from the terahertz waveform measurement can be used to find the barrier thickness and also where in the sample the barrier thickness is located with respect to inner and outer wall of the plastic bottle, preform, multilayer plastic medical device or rubber hose and tube.

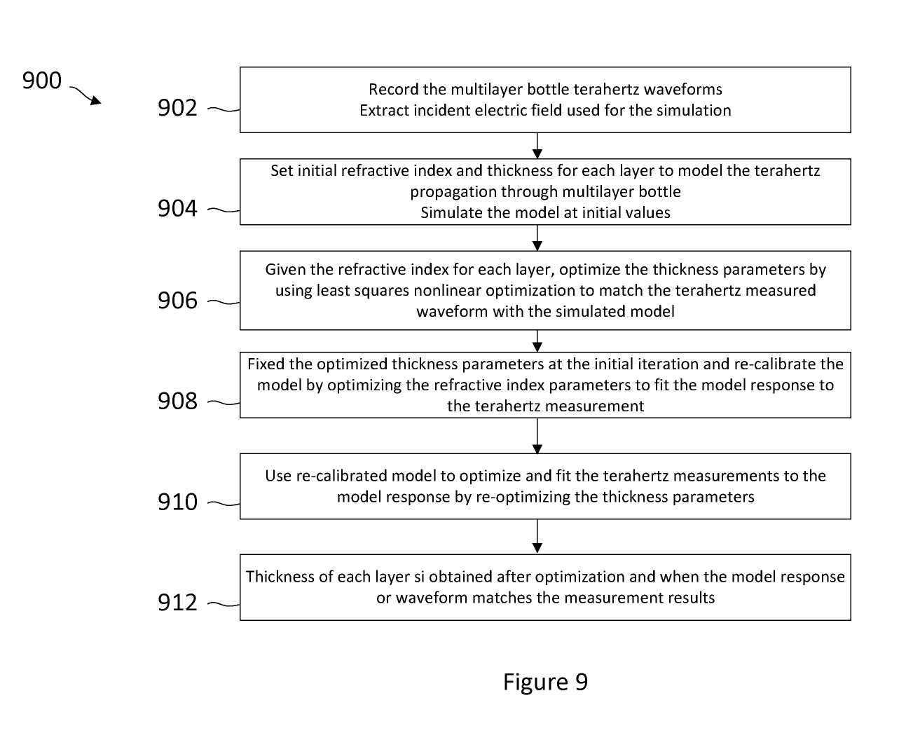

Referring now to FIG. 9 illustrated therein is a schematic diagram of a general simulation and optimization method 900 for determining thickness of individual layers and barrier thickness in multilayer transparent and opaque bottles using terahertz sensor system operating in reflection mode. The terahertz measurement system is first used to record, at 902, the multilayer bottle terahertz waveforms and the incident electric field terahertz pulse is extracted based on the refractive index of the first layer from the waveform and used for modelling and electromagnetic simulation using methods such as finite-different time domain (FDTD) simulation.

The initial refractive index and thickness for each layer to model the terahertz propagation through multilayer bottle is set at 904 and the model is simulated at initial values. At 906, given refractive index for each layer, next step is to optimize the thickness parameters by using least squares nonlinear optimization to match the terahertz measured waveform with the simulated model response. At 910, re-calibration optimization is performed by fixing the optimized thickness parameters at the initial iteration and re-calibrate the model by optimizing the refractive index parameters to fit the model response to the terahertz measurement. The re-calibrated model is used to optimize and fit the terahertz measurement to the model response by re-optimizing the model to find optimal thickness parameters. At 912, the thickness values are a final result when a criteria for matching the model with measurement is reached.

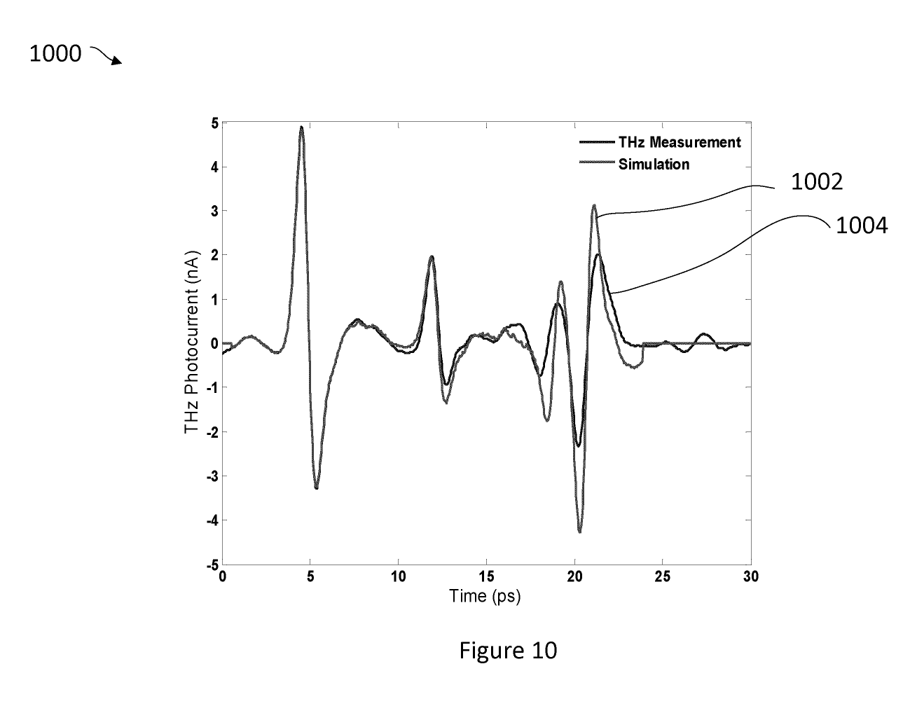

Referring now to FIG. 10 illustrated therein are measurement results 1000 collected from a terahertz sensor thickness measurement system with the measurement result 1004 and waveform after optimization and simulation 1002 of the model that matches measurement waveform. The thickness of each layer is optimized given a fixed refractive index in order to match the terahertz waveform measurement.

While the above description includes a number of exemplary embodiments, many modifications, substitutions, changes and equivalents will be obvious to persons having ordinary skill in the art.

While the above description provides examples of one or more apparatus, methods, or systems, it will be appreciated that other apparatus, methods, or systems may be within the scope of the claims as interpreted by one of skill in the art.

1. A method for measuring thicknesses of layers of a multi-layered structure, the method comprising:
generating a terahertz wave pulse;
transmitting the terahertz wave pulse to the multi-layered structure having multiple layers of materials;
receiving reflected terahertz wave pulses reflected by boundaries between the multiple layers as the terahertz wave pulse penetrates the multi-layered structure; and
processing the reflected terahertz wave pulses to: (i) measure time delays associated with each of the reflected terahertz pulses and (ii) determine a thickness of each of the multiple layers of materials based upon the time delays and a material refractive index of each of the materials.

2. The method of claim 1 further comprising determining a maximum peak of a first pulse reflection and a minimum peak of a last pulse reflection in the reflected terahertz wave and adding a region around the first pulse reflection with positive peak to the last pulse reflection with the negative peak after aligning the peaks of the first and last pulses in the reflected terahertz wave to determine an extracted barrier reflection pulse.

3. The method of claim 2, wherein the extracted barrier reflection pulse has a peak time delay at the time of reflection from the boundaries between the multiple layers.

4. The method of claim 3 further comprising storing a time index of the maximum peak of the first pulse reflection, the minimum peak of the last pulse reflection, and the extracted barrier reflection pulse.

5. The method of claim 1 further comprising extracting weak reflections from the reflected terahertz beam.

6. The method of claim 1 further comprising recording a terahertz signal monolayer waveform, recording a reference monolayer waveform, and subtracting the monolayer waveform from the terahertz signal monolayer waveform.

7. The method of claim 1 further comprising determining the overall thickness of the multi-layer structure.

8. The method of claim 1 wherein the multi-layer structure is a transparent and opaque preform and wherein the multi-layer structure includes a first layer, a second layer, and a barrier layer between the first layer and the second layer.

9. The method of claim 1 wherein, when the reflected terahertz wave pulses with sub-picosecond pulse width overlap, signal processing is performed to extract barrier reflections.

10. A system for measuring thicknesses of layers of a multi-layered structure, the system comprising:
a driver for producing a terahertz wave pulse;
a terahertz photoconductive transmitter for transmitting the terahertz wave pulse to the structure having multiple layers of materials;
a terahertz photoconductive receiver for receiving reflected terahertz wave pulses reflected by boundaries between the multiple layers as the terahertz wave pulse penetrates the multi-layered structure; and
a processor for processing the reflected terahertz wave pulses to: (i) measure time delays associated with each of the reflected terahertz pulses and (ii) determine a thickness of each of the multiple layers of materials based upon the time delays and a material refractive index of each of the materials.

11. The system of claim 10 further comprising a terahertz beam splitter for splitting the terahertz pulsed wave to form first and second wave beams.

12. The system of claim 11 further comprising a shaker for providing an optical delay in the second wave beam.

13. The system of claim 12 further comprising a translational stage and a retro-reflector mirror for changing the optical path delay in the second wave beam.

14. The system of claim 10 further comprising a low-noise amplifier for amplifying and converting the current from the terahertz photoconductive antenna to an amplified voltage signal that is recorded to form a terahertz waveform.

15. The system of claim 10 further comprising an exit parabolic mirror for separating the transmitted and received terahertz wave pulses.

16. The system of claim 10 further comprising a laser diode for indicating the position of terahertz focus of the multi-layered structure.

17. The system of claim 10 further comprising a pair of off axis mirrors for separating the transmitted and received terahertz wave pulses.

18. The system of claim 10 further comprising a plurality of dielectric mirrors for redirecting the terahertz wave pulse.

19. The system of claim 10 wherein the terahertz photoconductive transmitter and receiver are fixed to a gauge chassis.

20. The system of claim 10 wherein the multi-layer structure is a transparent and opaque preform and wherein the multi-layer structure includes a first layer, a second layer, and a barrier layer between the first layer and the second layer.
